(19) United States
(12) Patent Application Publication
(10) Pub. No.: US 2006/0121205 A1
(43) Pub. Date: Jun. 8, 2006

(54) Primerless integrated multilayer coating

(75) Inventors: Gregory G. Menovcik, Northville, MI (US); David J. Santure, Novi, MI (US); Lena Baizel, Farmington Hills, MI (US); Laura J. Neubauer, Milford, MI (US)

Correspondence Address: BASF CORPORATION;ANNE GERRY SABOURIN, 26701 TELEGRAPH ROAD, SOUTHFIELD, MI, 48034-2442, US

(73) Assignee: BASF Corporation, Southfield, MI (US)

(21) Appl. No.: 11/004,438

(22) Filed: Dec. 4, 2004

(51) Int. Cl. B32B 9/04; C25D 5/00; G11B 11/105; B05D 1/36

(52) U.S. Cl. 427/402; 428/332; 428/411.1; 205/80

(57) ABSTRACT

A multicoat coating system that does not contain a primer layer over an electrodeposition coating layer. Even in the absence of the primer layer, the electrodeposition coating layer is protected from ultraviolet light by a basecoat layer that contains a UV blocking composition comprising at least two of carbon black, iron oxide, titanium dioxide, and an aluminum pigment or mixtures of any these.

### BACKGROUND OF THE INVENTION

In a typical automotive coating process, there are many layers of coatings. Each coating layer is designed to impart certain properties to the coating system. A substrate is first coated with an electrodeposition (ED) coating. The ED coating is used for corrosion control. Over the ED coating, a primer/surfacer coating is applied. The primer is necessary to block ultra-violet (UV) rays from the sun from reaching the ED layer. Over the primer layer, one or more basecoat layers are applied. Basecoats provide the desired color to the substrate. Over the basecoat layer, one or more clearcoat layers are applied. Clearcoats provide scratch resistance, mar resistance, environmental protection, gloss, and distinctness of image (DOI) to the basecoat. A typical coating process is shown in FIG. 1.

ED coatings generally have no UV resistance. If UV light were to react with the ED coating layer, the ED coating layer would degrade, and the entire coating system could delaminate from the substrate. This problem occurred when ED coatings were first used. Basecoat layers did not block UV light from reaching the ED coating. Primers were added to protect the ED coating and prevent such delamination.

In order to protect the ED coating, typically the primer needs to be at least 1 mil (25.4 μm) thick to reduce the percentage of UV Light (electromagnetic radiation) that is transmitted through the primer to less than <0.1% transmittance between 290-360 nm and <0.5% transmittance at 400 nm. At film thicknesses at 0.5 mil (12.7 μm) or less, more than 10% of the UV light will be transmitted through the primer layer.

While primers are needed to protect ED coatings, the use of primers adds cost to the formation of the multilayer coating. First, there is the cost of the primer material, and the amount of uv blocking or absorbing material needed to provide UV protection. Also, a curing step is needed to cure the primer before a basecoat layer can be applied and the curing step consumes energy. the atmosphere. Also, there is a capital cost for an application system for the primer, which includes a primer prep-deck, an application booth, a primer cure oven, and a primer sand and inspection deck. This requires additional space in a coating line. Also, primers are generally solvent-based materials and the use of primers increases the amount of volatile organic compounds (VOC) emitted from a coating process.

It would be desirable to eliminate the primer from a coating system and still provide UV protection to the ED coating.

### SUMMARY OF THE INVENTION

A multilayer coating comprising
a) an electrodeposition coating layer on a substrate,
b) at least one first basecoat layer on the electrodeposition coating layer,
c) at least one second basecoat layer on the first basecoat layer,
d) at least one clearcoat layer on the second basecoat layer,
   wherein there is no primer layer between the electrodeposition coating layer and the first basecoat layer, and wherein the first basecoat layer is not greater than 0.6 mil (15.2 μm) thick and has an ultraviolet light transmittance so that less than 0.5% of ultraviolet light reaching the first basecoat layer passes through the first basecoat layer to the electrodeposition coating layer.

### BRIEF DESCRIPTION OF THE DRAWINGS

FIG. 1 is an illustration of a conventional coating process.

FIG. 2 is an illustration of a primeness 3-wet integrated process coating process.

FIG. 3 is a comparison graph of % ultraviolet light transmittance at different UV wavelengths of a taupe primer prepared with and without UV blocking composition according to Example 1. The examples with the UV blocking composition are compared at 0.3mil (7.6 μm) film thickness, and the examples without are prepared at 0.5 mil (12.7 μm) film thickness, and 1 mil (25.4 μm) film thickness, at 80% hiding, which gives 0.1% Transmittance from (290-360) nm and < 0.1 % transmittance @ 400 nm.

FIG. 4 is a graph and chart of % ultraviolet light transmittance at different wavelengths of a Silver Frost basecoat composition with and without the UV blocking composition prepared according to Ford Spec M6720 at a film thickness of 0.5 mil (12.7 μm).

FIG. 5 is a graph and chart of % ultraviolet light transmittance at different wavelengths of an Arizona Beige basecoat composition with and without the UV blocking composition prepared according to Ford Spec M6720 at a film thickness of 0.5 mil (12.7 μm).

FIG. 6 is a graph of % ultraviolet light transmittance at different wavelengths for an Green basecoat composition with the UV blocking composition

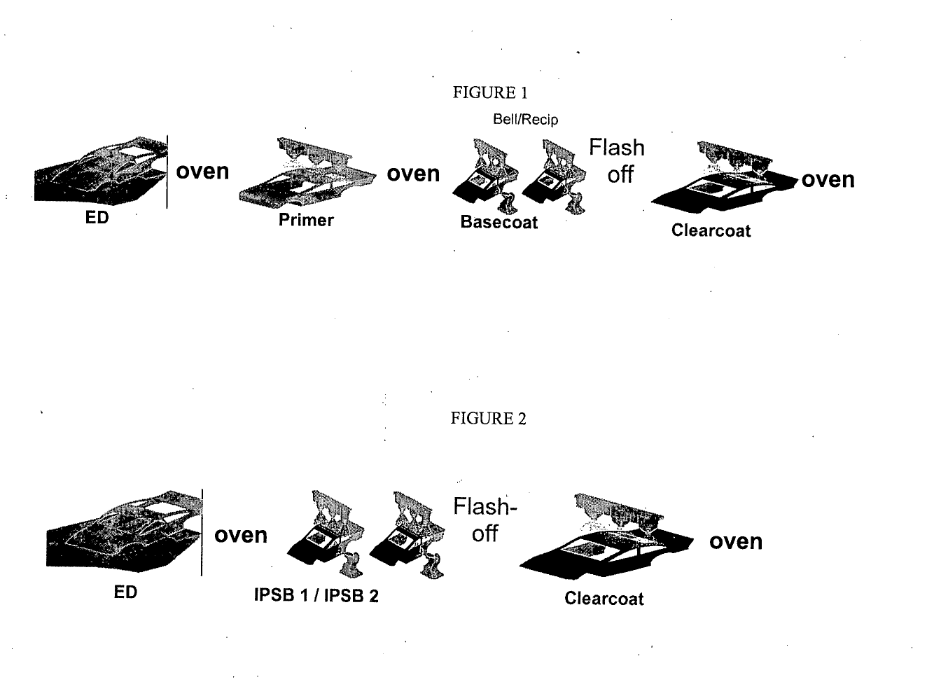

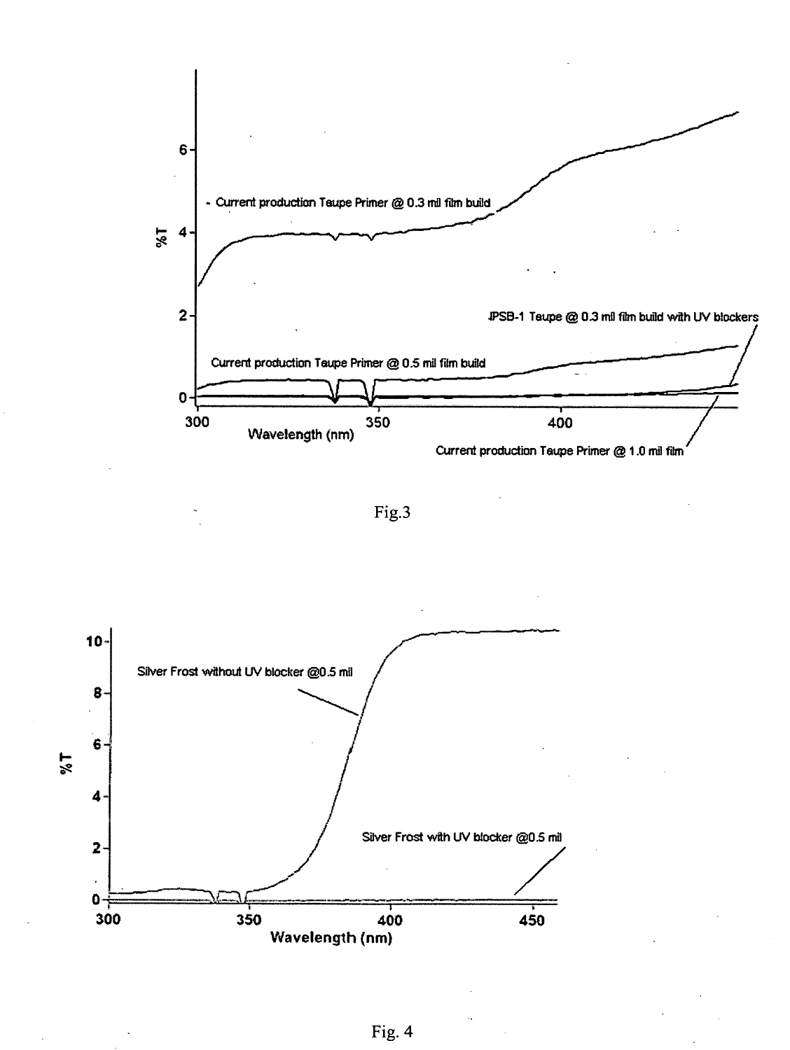

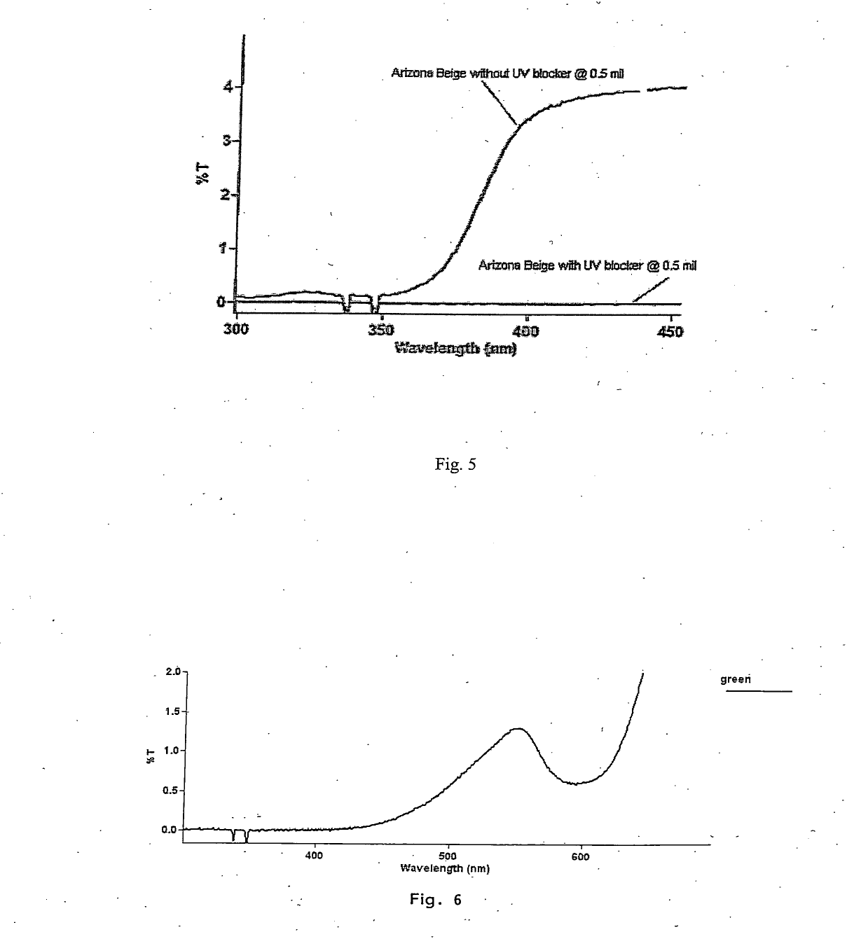

### DETAILED DESCRIPTION

As used throughout, ranges are used as shorthand for describing each and every value that is within the range. Any value within the range can be selected as the terminus of the range. When used, the phrase “at least one of” refers to the selection of any one member individually or any combination of the members. The conjunction “and” or “or” can be used in the list of members, but the “at least one of” phrase is the controlling language. For example, at least one of A, B, and C is shorthand for A alone, B alone, C alone, A and B, B and C, A and C, or A and B and C.

A multicoat coating system is provided that does not contain a primer layer. The multilayer coating comprises an electrodeposition (ED) coating layer on a substrate, at least one first basecoat layer on the electrodeposition coating layer, at least one second basecoat layer on the first basecoat layer, and at least one clearcoat layer on the second basecoat layer. In one embodiment, there is only one first basecoat layer. Two second basecoat layers are sometimes used to develop rich colors which provide vivid color effects.

UV protection for the ED layer is provided by a first basecoat layer. The first basecoat layer contains a UV blocking composition. The UV blocking composition comprises at least two of carbon black, iron oxide, titanium dioxide, and aluminum pigment, or any combination thereof.

The inclusion of the UV blocking composition allows the first basecoat layer to block the transmission of UV light through the first basecoat layer to the ED layer. The first basecoat layer can reduce the transmission of light starting in the ultraviolet range through the visible spectrum (i.e., 290-450 nm range). The first basecoat layer can block UV light so that less than 2% of UV light is transmitted through the first basecoat layer. Various embodiments provide transmission of UV light ranging from less than 1%, to less than 0.05%.

The reduction in UV transmittance can also be accomplished in coatings that are thinner than primer coating layers. Conventional primers are at least 1 mil (25.4 μm) thick. The first basecoat layer provides the UV blocking at thicknesses less than 1 mil (25.4 μm). In one embodiment, the thickness is less than 0.6 mil (15.2 μm), or less than 0.5 mil (12.7 μm), or less than 0.4 mil (10.2 μm). In one embodiment, the thickness is from 0.3 mil (7.61 μm) to 0.5 mil (12.7 μm). It is desired to use the thinnest film possible. This reduces the amount of coating required, which reduces the overall cost of the multilayer coating.

The first basecoat layer contains a binder in addition to the UV blocking composition. Any binder that can be used as a binder for automotive coatings can be used in the first basecoat layer. Polymers known in the art to be useful in basecoat compositions include acrylics, vinyls, polyurethanes, polycarbonates, polyesters, alkyds, polyepoxy and polysiloxanes as well as resins that are modified with or combinations of the aforementioned resin systems. Desirable polymers include acrylics and polyurethanes. In one embodiment of the invention, the basecoat composition also utilizes a carbamate-functional acrylic polymer. Basecoat polymers may be thermoplastic, but are preferably crosslinkable (i.e., thermoset) and comprise one or more type of crosslinkable functional groups. Such groups include, but are not limited to, hydroxy, isocyanate, amine, epoxy, acrylate, vinyl, silane, and acetoacetate groups. These groups may be masked or blocked in such a way so that they are unblocked and available for the crosslinking reaction under the desired curing conditions, generally at elevated temperatures. Useful crosslinkable functional groups include, but are not limited to, hydroxy, amino, epoxy, acid, anhydride, silane, and acetoacetate groups. In one embodiment, the binders are a blend of hydroxy polyester polymers and hydroxy acrylic polymers that are crosslinked with monomeric or polymeric melamines.

The pigments used as UV blockers are utilized in a pigment to binder weight ratio of between 0.30 to 0.50. The total pigment concentration based on total weight of the coating solid is between 10.0 and 18.0 % by weight.

The carbon black can be any carbon black pigment used for coating compositions. The carbon black is present in the first basecoat coating when used in combination with the other pigments in an amount to provide the desired reduction in ultraviolet light transmittance. The carbon black may be present in the basecoat composition in an amount from 0% up to about 10% by weight of pigment solids. In one embodiment, the carbon black is utilized in an amount from about 0.05 to about 1.0 % by weight of pigment solids (see Taupe pigment formulation). In the cured coating, the carbon black is present in an amount from about 0.05 to about 5.0% by weight of the cured coating, or from about 0.05 to about 1.0% by weight of the cured coating, or from about 0.22 to about 5.0% by weight of the cured coating.

The iron oxide can be any iron oxide pigment used for coating compositions. Examples of iron oxides include, but are not limited to, SICOTRANS™ RED L2818 red iron oxide, KROMA™ RED R03097, SICOTRANS™ yellow 1916 yellow iron oxide, MAPICO™ yellow 1050 yellow iron oxide. In some embodiments, red iron oxide performs better than yellow iron oxide. The iron oxide is present in the first basecoat coating composition in an amount that when used in combination with the other pigments, provides the desired reduction in ultraviolet light transmittance. In one embodiment, the iron oxide is present in the basecoat composition in an amount from about 5% to about 70% by weight of pigment solids. In the cured coating, the iron oxide is present in an amount from about 0.5 to about 20% by weight of the cured coating, or from about 5 to 10% by weight in the cured coating.

The titanium dioxide can be any titanium dioxide pigment used for coating compositions. Examples of titanium dioxides include, but are not limited to, TI-Pure™ R-706 titanium dioxide and Micro™ MT 500SA titanium dioxide. The titanium dioxide is present in the first basecoat coating composition in any amount when used in combination with the other pigments to provide the desired reduction in ultraviolet light transmittance. In one embodiment, the titanium dioxide is present in the basecoat composition in an amount from about 5% to about 75% by weight of pigment solids. In the cured coating, the titanium dioxide is present in an amount from about 5 to about 40 weight % by weight of the cured coating, or from about 20 to 30% by weight in the cured coating.

Effective aluminum pigments are those that can block UV light. Corn flake shaped aluminum pigments perform better than Silver dollar shaped aluminum pigment. Examples of aluminum pigments include, but are not limited to, STAPA Metallic 801 Ecart, TOYO aluminum 8160N-AR, STAPA 1515nl Ecart, STAPA Ecart, STAPA Metallux 2156 Ecart and SDS8-335 Aluminum.

Optionally, the aluminum pigment can be coated. The aluminum pigment is present in the first basecoat coating composition in any amount when used in combination with the other pigments to provide the desired reduction in ultraviolet light transmittance. In one embodiment, the aluminum pigment is present in the basecoat composition in an amount from about 1.0% to about 70% by weight of pigment solids. In the cured coating, the aluminum pigment is present in an amount from about 3.0 to about 20.0 weight % by weight of the cured coating, or from about 5 to 20% by weight of the cured coating.

UV blocking packages are based on the pigment types that are needed for matching the color standard of the first basecoat layer and the UV and visible light blocking capability measured from a range of 290 through 450 nm at 0.3 mils film build.

The electrocoat composition can be any electrocoat composition used for automotive coatings. Non-limiting examples of electrocoat compositions include the CATHOGUARD® electrocoating compositions sold by BASF, such as CATHOGUARD® 500.

The basecoat composition used for the first basecoat or the second basecoat can be any basecoat composition used for automotive coatings. In one embodiment, the basecoat composition is a liquid basecoat composition, a type of liquid composition is a solvent borne composition. In another embodiment, the basecoat composition is a powder basecoat composition. Basecoat compositions contain a binder and at least one pigment to provide the desired color to the multilayer coating system. Binders that can be used in the second basecoat composition include, but are not limited to, those described above the first basecoat composition. Polymers known in the art to be useful in basecoat compositions include acrylics, vinyls, polyurethanes, polycarbonates, polyesters, alkyds, polyepoxy and polysiloxanes. Desirable polymers include acrylics, polyurethanes and carbamate-functional acrylic polymer. Basecoat polymers may be thermoplastic, but are preferably crosslinkable (i.e., thermoset) and comprise one or more type of crosslinkable functional groups. Such groups include, for example, hydroxy, isocyanate, amine, epoxy, acrylate, vinyl, silane, and acetoacetate groups. These groups may be masked or blocked in such a way so that they are unblocked and available for the crosslinking reaction under the desired curing conditions, generally at elevated temperatures. Useful crosslinkable functional groups include hydroxy, amino, epoxy, acid, anhydride, silane, and acetoacetate groups.

Pigments used in the basecoat composition include any pigment that is used in automotive coatings to provide a desired color and/or effect.

The clearcoat composition can be any clearcoat composition used for automotive coatings. In one embodiment, the clearcoats can be formulated based on the following: hydroxyl acrylic and or polyester carbamate acrylic and or polyester combinations of the two functional groups, epoxy, blocked isocyanate systems known in the art as hybrid, and silane. They can also be combinations of these functional groups. They can be 2K systems or 1K systems. Examples of clearcoat compositions include, but are not limited to, the following clearcoat compositions from BASF: UNIGLOSS™, DURAGLOSS™, STARGLOSS™, UREGLOSS™, EVERGLOSS™, PROGLOSS™, TWINGLOSS™, SLURRYGLOSS™, CLEANGLOSS™.

In one embodiment, the basecoat compositions and the clearcoat composition are high solids solvent borne compositions. In one embodiment, the basecoat composition is from about 48 to about 52% non-volatiles, and the clearcoat composition is from about 52 to about 54% non-volatiles.

Any of the coating compositions can contain any additive that is typically added for its type of coating. Examples of coatings additives include, but are not limited to, surfactants, pigments, fillers, stabilizers, wetting agents, dispersing agents, adhesion promoters, UV absorbers, hindered amine light stabilizers, pH agents, and thickeners and mixtures of any of these additives.

The first basecoat layer can start to generate the color for the multilayer coating. In one embodiment, the color of the first basecoat is Arizona Beige, which is defined by Ford Specification M6985. By tinting to this color, any color can be used for the second basecoat. In another embodiment, the UV blocking composition can be added to a basecoat composition that does not contain pigment.

In one embodiment, the same composition can be used for the first basecoat and the second basecoat. This could eliminate the need for storing two different compositions. The UV blocking composition can be mixed with the second basecoat composition in line to form the first basecoat composition.

The UV blocking package can also be added to a primer type of formula, by removing some of the filler pigment and replacing this with the UV blocking pigment the same properties of blocking UV Light can be achieved.

The multilayer coating can be formed by the following steps. An electrodeposition coating on a substrate is either provided, or an electrodeposition coating composition is applied to a substrate, and the substrate is cured to form the electrodeposition coating. At least one first basecoat composition is applied to the electrodeposition coating layer, at least one second basecoat composition is applied to the first basecoat, and at least one clearcoat composition is applied to the second basecoat composition. Between application of each layer, the composition just applied can be cured alone or jointly cured with one or more previous layer(s), or the composition can be subjected to a flash. In one embodiment, all basecoat layers and clearcoat layers are applied wet on wet on wet to each other, and all basecoat and clearcoat layers are jointly cured. Also, between each basecoat layer, the basecoat layer can be cured and then selectively masked before a subsequent basecoat layer is applied. This can be done with different colors to provide a two or more Tu-tone color scheme.

When a powder basecoat coating composition, an electrodeposition coating on a substrate is either provided or an electodeposition coating composition is applied to a substrate to form an electrodeposition coating layer. A powder basecoat composition may be applied to a substrate having a wet or cured electrodeposition coating layer thereon, followed by application of a clearcoat composition. Between application of each layer, the composition just applied can be cured alone or jointly cured with one or more previous layer(s), or the composition can be subjected to a flash. In one embodiment all layers are applied and jointly cured. Also, if a two-tone or multi-tone color scheme is desired, between each basecoat layer, the basecoat layer can be cured and then selectively masked before a subsequent basecoat layer is applied.

The coating compositions can be coated on the substrate by any of a number of techniques well-known in the art. These include, for example, spray coating, dip coating, roll coating, curtain coating, and the like. For automotive body panels, spray coating is preferred.

Flashing can occur at any temperature and for any length of time, but the coating does not become fully cured. The temperature can range from ambient room temperature (the room temperature in the coating process area) up to about 40° F.-300° F. (4° C.-149° C.). The time can range from any time up to about 2 minutes to no upper limit. Flashing can be aided by the application of infra-red light or heat. In a one embodiment, flashing occurs at ambient room temperature for about 1.5 minutes. In one embodiment, after the last clearcoat composition is applied, flashing occurs at ambient room temperature for 5 to 8 minutes before the coating is cured.

Any method that is used to cure coatings can be used here. Two or more curing methods can be used in combination. Curing methods include, but are not limited to, heat and actinic radiation. Actinic radiation includes, but is not limited to, infra-red light, ultraviolet light, and electron beams. In one embodiment, curing is accomplished by passing the coatings through an oven. Any combination of temperature and time can be used to cure the coatings, and it is dependent upon the chemistry of each coating composition used. In one embodiment, the temperature in the oven ranges from about 230° F.(110° C.) to about 325° F.(163° C.). In one embodiment, curing time ranges from about 180° F. to about 350° F.

Other than the first basecoat layer, the other layers in the multilayer coating can have any property that is known in the art for these layers. Generally, the electrodeposition coating layer has a thickness ranging from about 0.7 mil (17.8 μm) to about 1.1 mil (27.9 μm), the first basecoat layer has a film thickness ranging from about 0.3 mil (7.6 μm) to about 0.7 mil (17.8 μm). The second basecoat layer has a thickness ranging from about 0.5 mil (12.7 μm) to about 1.0 mil (25.4 μm), and the clearcoat layer has a thickness ranging from about 1.0 mil (25.4 μm) to about 3.0 mil (76.2 μm).

The substrate to be coated can be any substrate. Examples of substrates include, but are not limited to, metal, wood, and plastic. Metal substrates include, but are not limited to, automotive body panels and automotive parts. Plastic substrates include, but are not limited to, automotive parts and polymer films.

### SPECIFIC EMBODIMENTS OF THE INVENTION

The invention is further described in the following examples. The examples are merely illustrative and do not in any way limit the scope of the invention as described and claimed.

### EXAMPLE 1

### Basecoat Formulation

The following components were combined to form a solventborne basecoat according to the present invention. The pigment mixtures set forth below were added to the basecoat to obtain a basecoat having an ultraviolet light transmittance so that less than 0.5% of ultraviolet light penetrates the basecoat when applied at not greater than 0.6 mil (15.2 μm) thickness.

| Ingredient | Amt. |
|---|---|
| Thermosetting acrylic resin microgel | 35.74 |
| N-Methylpyrrolidone | 1.19 |
| Normal Butyl Acetate | 8.05 |
| AMINO METHYL PROPANOL | 0.18 |
| RESIMENE 755 Melamine Resin | 12.66 |
| Acrylic Polymer wetting agent | 0.09 |
| Tinuvin 384-2 Benzotriazole UVA | 0.77 |
| U.V. ABSORBER SOLUTION-Tinuvin 328 | 2.58 |
| Tinuvin 123 HALS | 0.53 |
| Fumed Silica | 11.08 |
| Barium Sulfate | 2.64 |
| Flexible Acrylic Resin | 20.37 |
| Dodecyl benzene sulfonic acid catalyst | 2.13 |
| Ethanol | 1.09 |
| Isopropanol | 0.90 |
| Total | 100 |

Pigment mixtures were added to basecoat formulation set forth in Example 1 to form the following colored basecoats.

### EXAMPLE 2

### Taupe Formulation

| Pigment | % weight on formula | % weight on pigment |
|---|---|---|
| Microfine Barium Sulfate | 3.8 | 30.67 |
| Fumed Silica | 1.367 | 11.03 |
| Carbon Black | 0.084 | 0.67 |
| Titanium Dioxide | 3.814 | 30.78 |
| Iron | 3.323 | 26.82 |

P/B = 0.326
Pigment volume concentration = 8.618
Pigment weight = 12.39

### EXAMPLE 3

### Silver Frost

| Pigment | % weight on formula | % weight on pigment |
|---|---|---|
| Aluminum | | 6.64 |
| Fumed Silica | 1.304 | 10.72 |
| Titanium Dioxide | 9.126 | 75.01 |
| Yellow Iron Oxide | 0.432 | 3.55 |
| Iron Oxide | 0.497 | 4.08 |

P/B = 0.329
Pigment volume concentration = 9.419
Pigment weight = 12.16

### EXAMPLE 4

### Green Formulation

| Pigment | % weight on formula | % weight on pigment |
|---|---|---|
| | 1.415 | 10.51 |
| Fumed Silica | 1.09 | 8.1 |
| Titanium Dioxide | 7.628 | 56.68 |
| Iron Oxide | 3.324 | 24.7 |

P/B = 0.383
Pigment volume concentration = 10.897
Pigment weight = 13.45

Additional Basecoat compositions may be formulated using the following pigment components.

| | Example 5 | Example 6 | Example 7 | Example 8 |
|---|---|---|---|---|
| | % wt on | % wt on | % wt on | % wt on |
| Pigment | pigment | pigment | pigment | pigment |
| Aluminum Pigment | 5.44 | 2.35 | 0.89 | 2.78 |
| Microfine Barium Sulfate | 30.67 | 23.04 | 28.65 | 23.89 |
| Fumed Silica | 11.03 | 11.03 | 11.03 | 11.03 |
| Carbon Black | 0.677 | 0.52 | 0.32 | |
| Yellow Iron Oxide | | 3.55 | | 3.55 |
| Titanium Dioxide | 25.34 | 39.28 | 27.04 | 40.15 |
| Red Iron Oxide | 26.82 | 20.23 | 32.07 | 18.6 |

It should be appreciated that the present invention is not limited to the specific embodiments described above, but includes variations, modifications and equivalent embodiments defined by the following claims.

What is claimed is:

1. A multilayer coating comprising
a. an electrodeposition coating layer on a substrate,
b. at least one first basecoat layer on the electrodeposition coating layer,
c. at least one second basecoat layer on the first basecoat layer,
d. at least one clearcoat layer on the second basecoat layer,
wherein there is no primer layer between the electrodeposition coating layer and the first basecoat layer, and wherein the first basecoat layer is not greater than 0.6 mil (15.2 μm) thick and has an ultraviolet light transmittance so that less than 0.5% of ultraviolet light reaching the first basecoat layer passes through the first basecoat layer to the electrodeposition coating layer.

2. The multilayer coating of claim 1, wherein the basecoat layer comprises at least two compounds selected from the group consisting of carbon black, iron oxide, titanium dioxide, and an aluminum pigment and mixtures thereof in an amount to achieve the ultraviolet light transmittance.

3. The multilayer coating of claim 2, wherein the carbon black is present in the first basecoat layer in an amount from 0.5 to 5.0 weight % of carbon black by weight of the coating.

4. The multilayer coating of claim 2, wherein the iron oxide is present in the first basecoat layer in an amount from 0.5 to 20.0 weight % of iron oxide by weight of the coating.

5. The multilayer coating of claim 2, wherein the titanium dioxide is present in the first basecoat layer in an amount from 5 to 40 weight % of titanium dioxide by weight of the coating.

6. The multilayer coating of claim 2, wherein the aluminum pigment is present in the first basecoat layer in an amount from 3.0 to 20 weight % of aluminum pigment by weight of the coating.

7. The multilayer coating of claim 1, wherein the amount of ultraviolet light transmittance is less than 0.2%.

8. The multilayer coating of claim 1, wherein the amount of ultraviolet light transmittance is less than 0.05%.

9. The multilayer coating of claim 1, wherein the first basecoat layer is not greater than 0.5 mil (12.7 μm) thick.

10. The multilayer coating of claim 1, wherein the first basecoat layer is 0.3 mil (7.6 μm) to 0.5 mil (12.7 μm) thick.

11. The multilayer coating of claim 1, wherein the first basecoat layer is 0.3 mil (7.6 μm) to 0.5 mil (12.7 μm) thick and the amount of ultraviolet light transmittance is less than 0.05%.

12. The multilayer coating of claim 1, wherein the first and second basecoat layers are powder coatings.

13. The multilayer coating of claim 1, wherein the first and second basecoat layers are solvent borne coatings.

14. A method of making a multilayer coating comprising
a) one of
ii) applying an electrodeposition coating composition to a substrate, and curing the electrodeposition coating to form an electrodeposition coating layer, or
ii) providing a substrate with an electrodeposition coating layer on the substrate,
b) applying a first basecoat composition the electrodeposition coating layer, applying at least one second basecoat composition to the first basecoat,
d) applying at least one clearcoat composition to the second basecoat, and curing by one of:
i) the second basecoat composition is applied to the first basecoat composition wet on wet, the clearcoat composition is applied to the second basecoat composition wet on wet, and the first basecoat composition, the second basecoat composition, and the clearcoat composition are jointly cured, or
ii) each layer is cured individually before the application of a subsequent layer, or
iii) combinations of layers are jointly cured before the application of a subsequent layer,
to form a first basecoat layer, a second basecoat layer, and a clearcoat layer, or
wherein the first basecoat layer is not greater than 0.6 mil (15.2 μm) thick, and wherein the carbon black, the titanium dioxide, the iron oxide, and the aluminum pigment are present in the first basecoat layer in an amount so that less than 0.5% of ultraviolet light reaching the first basecoat layer passes through the first basecoat layer to the electrodeposition coating layer.

15. The method of claim 14, wherein the basecoat layer comprises at least two compounds selected from the group consisting of carbon black, titanium dioxide, iron oxide, and an aluminum pigment in an amount to achieve the ultraviolet light transmittance.

16. The method of claim 14, wherein the curing is performed by step i).

17. The method of claim 15, wherein the first basecoat composition is formed by mixing carbon black, titanium dioxide, iron oxide, and an aluminum pigment with the second basecoat composition.

18. The method of claim 15, wherein the carbon black is present in the first basecoat layer in an amount from 0.5 to 5.0 weight % of carbon black by weight of the coating.

19. The method of claim 15, wherein the iron oxide is present in the first basecoat layer in an amount from 0.5 to 20.0 weight % of iron oxide by weight of the coating.

20. The method of claim 15, wherein the titanium dioxide is present in the first basecoat layer in an amount from 5 to 40 weight % of titanium dioxide by weight of the coating.

21. The method of claim 15, wherein the aluminum pigment is present in the first basecoat layer in an amount from 3.0 to 20 weight % of aluminum pigment by weight of the coating.

22. The method of claim 14, wherein the amount of ultraviolet light transmittance is less than 0.2%.

23. The method of claim 14, wherein the amount of ultraviolet light transmittance is less than 0.05%.

24. The method of claim 14, wherein the first basecoat layer is not greater than 0.5 mil (12.7 μm) thick.

25. The method of claim 14, wherein the first basecoat layer is 0.3 mil (7.6 μm) to 0.5 mil (12.7 μm) thick.

26. The method of claim 14, wherein the first basecoat layer is 0.3 mil (7.6 μm) to 0.5 mil (12.7 μm) thick and the amount of ultraviolet light transmittance is less than 0.05%.

27. The method of claim 14 wherein the first and second basecoat layers are solventborne coating compositions.

28. The method of claim 14 wherein the first and second basecoat layers applied are powder coating compositions.

29. The method of claim 16 wherein the first and second basecoat layers applied are powder coating compositions.

30. A coating composition comprising a binder, carbon black, titanium dioxide, iron oxide, and an aluminum pigment, wherein the carbon black, the titanium dioxide, the iron oxide, and the aluminum pigment are present in an amount so that less than 0.5% of ultraviolet light passes through a coating formed from the coating composition that is not greater than 0.6 mil (15.2 μm) thick.
